(19) United States
(12) Patent Application Publication
(10) Pub. No.: US 2008/0159121 A1
(43) Pub. Date: Jul. 3, 2008

(54) WRITE-ONCE OPTICAL RECORDING MEDIUM

(75) Inventors: Huan-Chien TUNG, Kaohsiung Hsien (TW); Liu-Wen Chang, Kaohsiung City (TW); Yeong-Tsuen Pan, Haosiung City (TW); Jui-Tung Chang, Tainan City (TW); Jye-Long Lee, Kaohsiung City (TW)

Correspondence Address: FOLEY AND LARDNER LLP;SUITE 500, 3000 K STREET NW, WASHINGTON, DC, 20007, US

(73) Assignee: CHINA STEEL CORPORATION

(21) Appl. No.: 11/834,208

(22) Filed: Aug. 6, 2007

(30) Foreign Application Priority Data
Dec. 27, 2006 (TW) 095149194

(51) Int. Cl. G11B 3/70

(52) U.S. Cl. 369/286

(57) ABSTRACT

A write-once optical recording medium includes a substrate, and a recordable film formed on the substrate. The recordable film includes a recording layer containing a component selected from germanium (Ge), antimony (Sb), silicon (Si), and mixtures thereof, and a reflective layer containing a component selected from aluminum (Al), copper (Cu), silver (Ag), gold (Au), and mixtures thereof.

### CROSS-REFERENCE TO RELATED APPLICATION

This application claims priority of Taiwanese application no. 095149194, filed on Dec. 27, 2006.

### BACKGROUND OF THE INVENTION

1. Field of the Invention

This invention relates to a write-once optical recording medium, more particularly to a write-once optical recording medium including a recordable film having a recording layer made from a component selected from Group IVA and Group VA elements, and mixtures thereof, and a reflective layer made from a component selected from Group IIIA and Group IB elements, and mixtures thereof.

2. Description of the Related Art

Referring to FIG. 1, a conventional write-once optical recording medium 1 includes a dielectric layer 12, a recording layer 13, and a reflective layer 14 in the described order stacked on a top surface 111 of a substrate 11. When a recording laser beam enters the optical recording medium 1 through irradiating a bottom surface 112 of the substrate 11, the incident laser beam will be refracted by the dielectric layer 12 and will vertically enter the recording layer 13. The recording layer 13 will be subsequently induced to undergo a local reaction and to form a recorded mark of digital signals, thereby recording and storing important data.

Traditionally, the recording layer 13 is made from organic dyes. With increasing demand for the optical recording medium 1 with high recording density, application of the organic dyes to the recording layer 13 of the optical recording medium 1 is restricted due to high internal stress, a narrow range of absorbable light wavelengths, and low transmittance of the organic dyes per se.

In recent years, in organic material has been developed for the manufacture of the recording layer 13 of the write-once optical recording medium 1. For example, U.S. Pat. No. 5,252,370 has proposed an inorganic recording layer containing silver oxide and/or iron nitride; U.S. Pat. No. 4,624,914 has proposed a photosensitive thin layer consisting essentially of tellurium oxide and palladium; and Taiwanese Patent No. I24097 has proposed a recording layer made from nickel oxides. However, all the recording layers suggested in the above prior art references are preferably formed through the radio frequency sputtering or reactive sputtering techniques. Production cost of these recording layers is relatively high, and the productivity of the same is relatively low.

In addition, U.S. Pat. No. 4,960,680 discloses a recording layer made from antimony-indium-tin alloy; and U.S. Pat. No. 7,067,183 discloses a recording layer made from a mixture of silicon and aluminum. Taiwanese Patent No. I231500 discloses a recording layer composed of two or more sub-recording layers made from aluminum and antimony. When a laser beam irradiates the recording layer, antimony and aluminum contained in the sub-recording layers will diffuse and be mixed, thereby forming a recorded mark. Although these prior art references provide more choices of recording layer materials, manufacture of the recording layer from these materials involves relatively complicated processing procedures and results in relatively high production cost and poor popularity.

### SUMMARY OF THE INVENTION

Therefore, the object of the present invention is to provide a write-once optical recording medium that can alleviate the aforesaid drawbacks of the prior art.

According to this invention, a write-once optical recording medium includes a substrate, and a recordable film formed on the substrate. The recordable film includes a recording layer containing a component selected from the group consisting of germanium (Ge), antimony (Sb), silicon (Si), and mixtures thereof, and a reflective layer containing a component selected from the group consisting of aluminum (Al), copper (Cu), silver (Ag), gold (Au), and mixtures thereof.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a fragmentary schematic view to illustrate a conventional write-once optical recording medium;

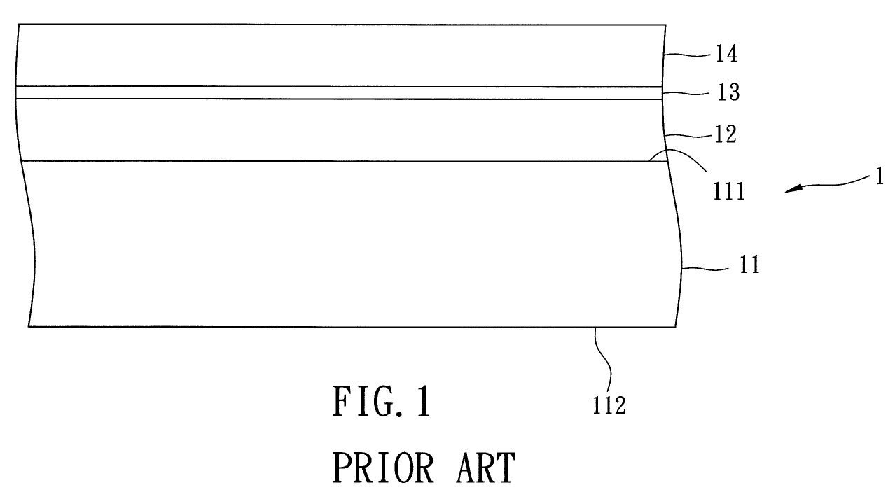

FIG. 2 is a fragmentary schematic view to illustrate the first preferred embodiment of a write-once optical recording medium according to this invention;

FIG. 3 is a fragmentary schematic view to illustrate the second preferred embodiment of a write-once optical recording medium according to this invention;

FIG. 4 is a fragmentary schematic view to illustrate the third preferred embodiment of a write-once optical recording medium according to this invention;

FIG. 5 is a fragmentary schematic view to illustrate the fourth preferred embodiment of a write-once optical recording medium according to this invention;

FIG. 6 is a fragmentary schematic view to illustrate the fifth preferred embodiment of a write-once optical recording medium according to this invention; and

FIG. 7 is a fragmentary schematic view to illustrate the sixth preferred embodiment of a write-once optical recording medium according to this invention.

### DETAILED DESCRIPTION OF THE PREFERRED EMBODIMENTS

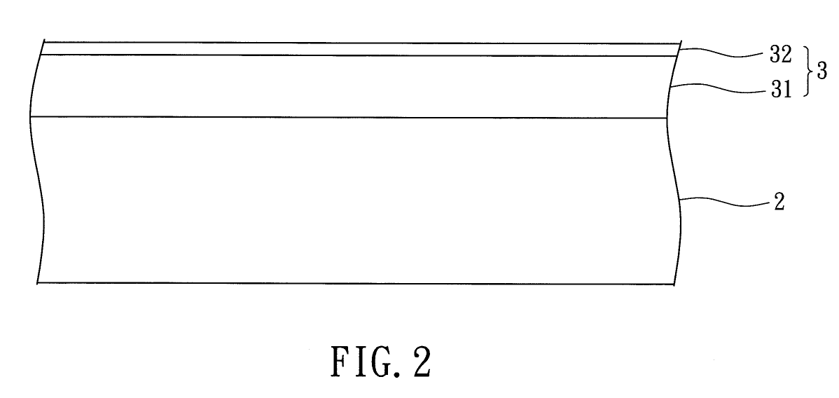

Referring to FIG. 2, the first preferred embodiment of a write-once optical recording medium 2 according to this invention includes a substrate 2, and a recordable film 3 formed on the substrate 2. In this embodiment, the recordable film 3 includes a recording layer 31 formed on the substrate 2, and a reflective layer 32 formed on the recording layer 31.

Preferably, the substrate 2 is made from a transparent material selected from the group consisting of glass, polycarbonate, and polymethyl methacrylate. More preferably, the substrate 2 is made from glass.

Preferably, the recording layer 31 has a thickness ranging from 10 nm to 100 nm. More preferably, the recording layer 31 has a thickness of about 30 nm. Preferably, the recording layer 31 contains a component selected from the group consisting of germanium (Ge), antimony (Sb), silicon (Si), and mixtures thereof. More preferably, the component is Ge. The atom percentage of the component is required to be higher than 80% so as to satisfy the specification of blue-ray discs. Preferably, the atom percentage of the component in the recording layer 31 ranges from 80% to 100%.

Alternatively, the recording layer 31 may further contain an additive, such as chromium (Cr), and the atom percentage of the additive in the recording layer 31 ranges from 0.01% to 20%.

Preferably, the reflective layer 32 has a thickness ranging from 80 nm to 200 nm. More preferably, the reflective layer 32 has a thickness of about 200 nm. Preferably, the reflective layer 32 contains a component selected from the group consisting of aluminum (Al), copper (Cu), silver (Ag), gold (Au), and mixtures thereof. More preferably, the component is Ag. Preferably, the atom percentage of the component in the reflective layer 32 ranges from 93% to 100%.

In another preferred arrangement, the reflective layer 32 further contains a reflectivity-enhancing additive that has an atom percentage ranging from 0.01% to 3.0% and that is selected from the group consisting of Pd, Cu, Pt and alloys thereof; a corrosion resistance-enhancing additive that has an atom percentage ranging from 0.01% to 2.0% and that is selected from the group consisting of Sc, Be, Ti, Cr, Zn, Ni, and alloys thereof; and a mechanical strength-enhancing additive that has an atom percentage ranging from 0.01% to 2.0% and that is selected from the group consisting of Ba, Sc, Si, Ti, In, Ge, Zn, Bi, and alloys thereof.

It is noted that when the reflectivity-enhancing additive is added in an atom percentage higher than 3.0%, the reflectivity of the reflective layer 32 will decrease with increase in the atom percentage of the reflectivity-enhancing additive. When the corrosion resistance-enhancing additive is added in an atom percentage higher than 2.0%, the reflectivity of the reflective layer 32 will deteriorate. When the mechanical strength-enhancing additive is added in an atom percentage higher than 2.0%, precipitate thereof will be formed in the reflective layer 32.

In one example of the first embodiment of this invention, the write-once optical recording medium includes the substrate 2 made from glass, the recording layer 31 having a thickness of 30 nm and made from 90 at % of Ge and 10 at % of Cr, and the reflective layer 32 having a thickness of 200 nm and made from 98.2 at % of Ag, 1.2 at % of Pt, 0.3 at % of Cu, 0.1 at % of Sc, and 0.2 at % of Ni.

In another example of the first embodiment of this invention, the write-once optical recording medium has a structure and a composition of each constituted layer similar to those of the above example, except for the recording layer 31 made from Ge. Particularly, when a recording laser beam having a wavelength of 405 nm (not shown) enters the write-once optical recording medium from the substrate 2, energy and time required to conduct a local reaction at the interface between the recording layer 31 and the reflective layer 32 are low and short, respectively. Thus, formation of the recorded mark for digital signals through the local reaction between the recording layer 31 and the reflective layer 32 can be speeded up.

In yet another example of the first embodiment of this invention, the write-once optical recording medium has a structure and a composition of each constituted layer similar to those of the above example, except for the recording layer 31 made from Si and the reflective layer 32 made from Al. Particularly, when a recording laser beam having a wavelength of 405 nm (not shown) enters the write-once optical recording medium from the substrate 2, a local reaction will occur at the interface between the recording layer 31 and the reflective layer 32 so as to form a solid solution of Si and Al as the recorded mark for digital signals.

In still another example of the first embodiment of this invention, the write-once optical recording medium has a structure and a composition of each constituted layer similar to those of the above example, except for the recording layer 31 made from Sb and the reflective layer 32 made from Ag. Particularly, when a recording laser beam having a wavelength of 405 nm (not shown) enters the write-once optical recording medium from the substrate 2, a local reaction will occur at the interface between the recording layer 31 and the reflective layer 32 so as to form a solid solution of Sb and Ag as the recorded mark for digital signals.

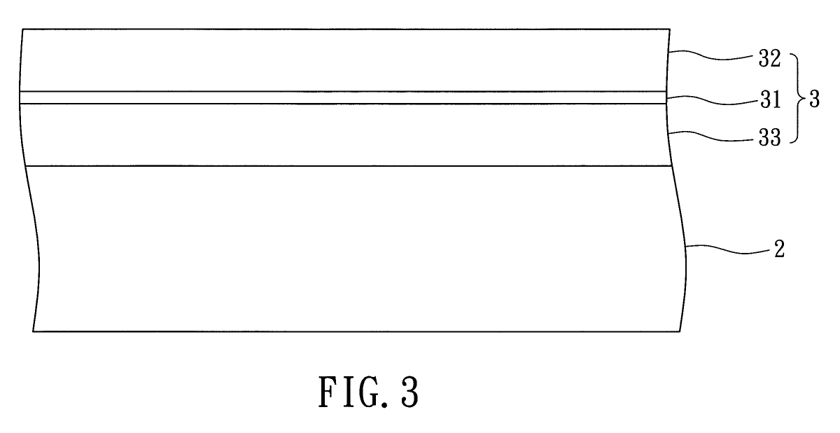

Referring to FIG. 3, the second preferred embodiment of the write-once optical recording medium of this invention has a structure similar to that of the first preferred embodiment, except that the recordable film 3 further includes a dielectric layer 33 interposed between the substrate 2 and the recording layer 31.

Preferably, the dielectric layer 33 has a thickness ranges from 50 nm to 300 nm. More preferably, the dielectric layer 33 has a thickness of about 150 nm. Preferably, the dielectric layer 33 is made from a material selected from the group consisting of zinc sulfide-silicon dioxide, alumina, zicornia, titania and silicon carbide. More preferably, the dielectric layer 33 is made from zinc sulfide-silicon dioxide.

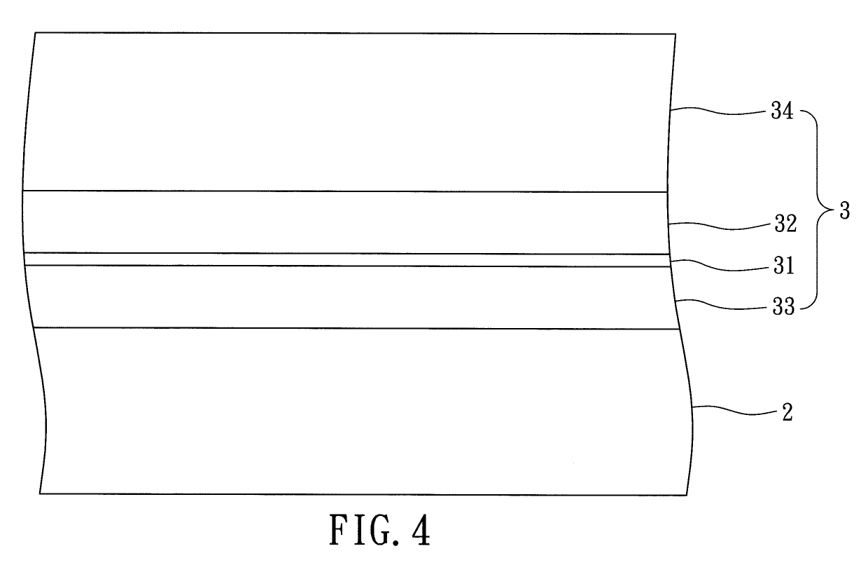

Referring to FIG. 4, the third preferred embodiment of the write-once optical recording medium of this invention has a structure similar to that of the second preferred embodiment, except that the recordable film 3 further includes a protective layer 34 formed on the reflective layer 32. The protective layer 34 is used for protecting the reflective layer 32 from damage. Preferably, the protective layer 34 is made from a photocurable resin.

Since the compositions and the thicknesses of the substrate 2, the recording layer 31 and the reflective layer 32 in both the second and third preferred embodiments of this invention are similar to those of the first preferred embodiment, the detailed descriptions thereof will be omitted herein.

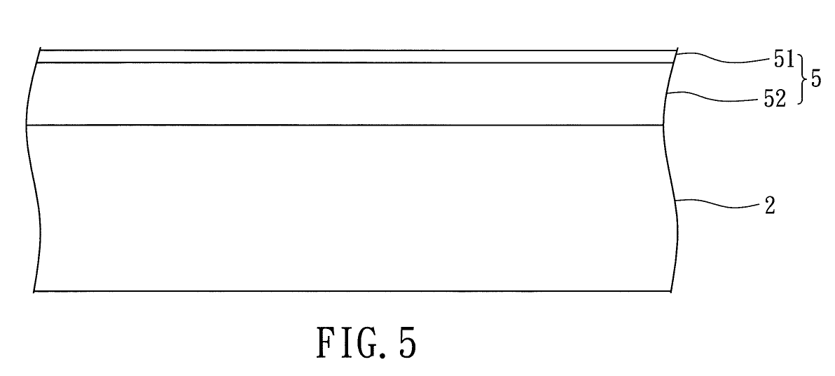

Referring to FIG. 5, the fourth preferred embodiment of the write-once optical recording medium of this invention includes a substrate 2, and a recordable film 5 formed on the substrate 2. In this embodiment, the recordable film 3 includes a reflective layer 52 formed on the substrate 2, and a recording layer 51 formed on the reflective layer 52.

Since the compositions and the thicknesses of the recording layer 51 and the reflective layer 52 in the fourth preferred embodiment of this invention are similar to those of the first preferred embodiment, the detailed descriptions thereof will be omitted herein.

In one example of the fourth embodiment of this invention, the write-once optical recording medium includes the substrate 2 made from glass, the recording layer 51 having a thickness of 30 nm and made from 95 at % of Ge and 5 at % of Cr, and the reflective layer 52 having a thickness of 200 nm and made from 97.2 at % of Ag, 0.9 at % of Pt, 0.9 at % of Cu, and 1 at % of Au.

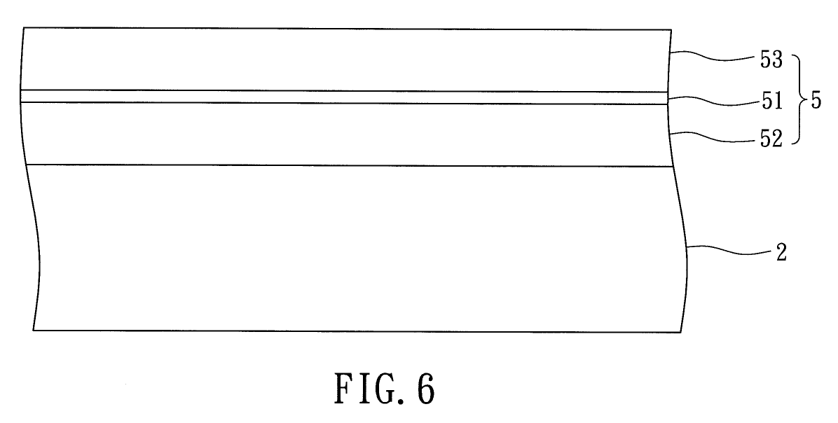

Referring to FIG. 6, the fifth preferred embodiment of the write-once optical recording medium of this invention has a structure and a composition of each constituted layer similar to those of the fourth preferred embodiment, except that the recordable film 5 further includes a dielectric layer 53 formed on the recording layer 51.

Preferably, the dielectric layer 53 has a thickness ranging from 50 nm to 300 nm. More preferably, the dielectric layer 53 has a thickness of about 150 nm. Preferably, the dielectric layer 53 is made from a material selected from the group consisting of zinc sulfide-silicon dioxide, alumina, zicornia, titania and silicon carbide. More preferably, the dielectric layer 53 is made from zinc sulfide-silicon dioxide.

In one example of the fifth embodiment of this invention, the write-once optical recording medium includes the substrate 2 made from glass, the recording layer 51 having a thickness of 30 nm and made from 95 at % of Ge and 5 at % of Cr, the reflective layer 52 having a thickness of 200 nm and made from 97.2 at % of Ag, 0.9 at % of Pt, 0.9 at % of Cu, and 1 at % of Au, and the dielectric layer 53 having a thickness of 150 nm and made from zinc sulfide-silicon dioxide. Particularly, when a recording laser beam having a wavelength of 405 nm (not shown) enters the write-once optical recording medium from the dielectric layer 53, a local reaction will occur at the interface between the recording layer 51 and the reflective layer 52 so as to form a solid solution of Ge and Ag as the recorded mark for digital signals.

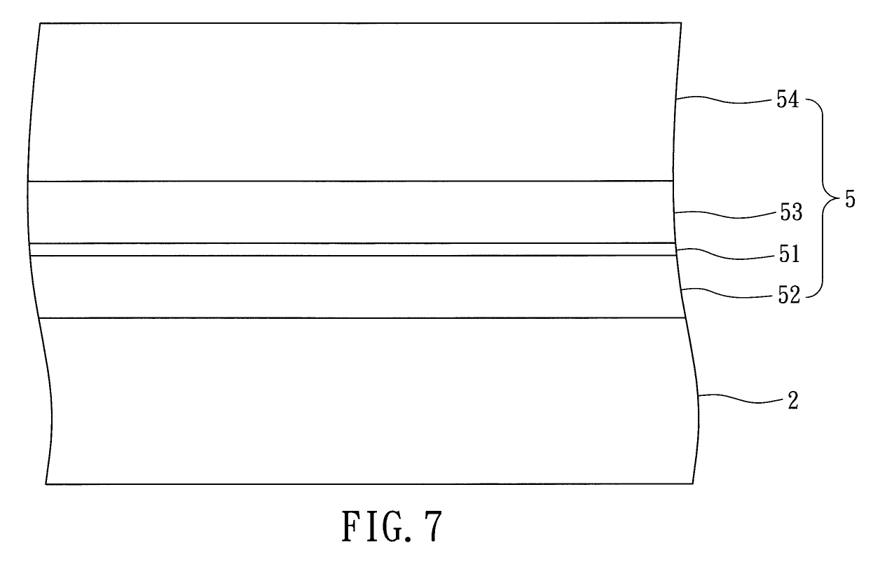

Referring to FIG. 7, the sixth preferred embodiment of the write-once optical recording medium of this invention has a structure and a composition of each constituted layer similar to those of the fifth preferred embodiment, except that the recordable film 5 further includes a protective layer 54 formed on the dielectric layer 53. The protective layer 54 is used for protecting the dielectric layer 53 from damage. Preferably, the protective layer 54 is made from a photocurable resin.

In addition, in the first to sixth preferred embodiments, the substrate 2 may be formed with a plurality of light-guiding grooves (not shown) by any method known in the art.

In view of the foregoing, by virtue of the structure of the write-once optical recording medium and the composition of each constituted layer, a recorded mark is formed at the interface between the recording layer 31, 51 and the reflective layer 32, 52 by irradiating the write-once optical recording medium with the recording laser beam. Specifically, when the recording laser beam respectively irradiates the recording layer 31, 51, a local reaction occurs at the interface between the recording layer 31, 51 and the reflective layer 32, 52, which results in a change in reflectivity of the irradiated area at the interface. More specifically, the reflectivity of the irradiated area at the interface is higher than other non-irradiated areas by 45% or more.

In addition, the recording layer 31, 51 can be formed through direct current sputtering techniques. Hence, the production cost incurred during the manufacture of the write-once optical recording medium can be significantly reduced, while the productivity thereof can be significantly increased. Besides, not only can the reflective layer 32, 52 react with the recording layer 31, 51 to form the recorded mark, it can also reflect a reading laser beam for reading the recorded mark. Hence, the number of the recordable film 3, 5 can be reduced.

Therefore, compared to the conventional write-once optical recording medium 1 having the recording layer 13 made from the organic dyes, in addition to a simpler manufacturing procedure and a lower production cost, the write-once optical recording medium of this invention has higher recording density, good climatic endurance, and longer service life and is more suitable for high capacity recording applications.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A write-once optical recording medium, comprising:
a substrate; and
a recordable film formed on said substrate, said recordable film including a recording layer containing a component selected from the group consisting of germanium (Ge), antimony (Sb), silicon (Si), and mixtures thereof, and a reflective layer containing a component selected from the group consisting of aluminum (Al), copper (Cu), silver (Ag), gold (Au), and mixtures thereof.

2. The write-once optical recording medium of claim 1, wherein said recording layer is formed on said substrate, said reflective layer being formed on said recording layer.

3. The write-once optical recording medium of claim 2, wherein said recordable film further includes a dielectric layer interposed between said substrate and said recording layer.

4. The write-once optical recording medium of claim 3, wherein said dielectric layer is made from a material selected from the group consisting of zinc sulfide-silicon dioxide, alumina, zicornia, titania and silicon carbide.

5. The write-once optical recording medium of claim 3, wherein said recordable film further includes a protective layer formed on said reflective layer.

6. The write-once optical recording medium of claim 5, wherein said protective layer is made from a photocurable resin.

7. The write-once optical recording medium of claim 1, wherein said reflective layer is formed on said substrate, said recording layer being formed on said reflective layer.

8. The write-once optical recording medium of claim 7, wherein said recordable film further includes a dielectric layer formed on said recording layer.

9. The write-once optical recording medium of claim 8, wherein said dielectric layer is made from a material selected from the group consisting of zinc sulfide-silicon dioxide, alumina, zicornia, titania and silicon carbide.

10. The write-once optical recording medium of claim 8, wherein said recordable film further includes a protective layer formed on said dielectric layer.

11. The write-once optical recording medium of claim 10, wherein said protective layer is made from a photocurable resin.

12. The write-once optical recording medium of claim 1, wherein said substrate is made from a transparent material selected from the group consisting of glass, polycarbonate, and polymethyl methacrylate.

13. The write-once optical recording medium of claim 1, wherein said recording layer contains Ge in an atom percentage ranging from 80% to 100%.

14. The write-once optical recording medium of claim 13, wherein said recording layer further contains chromium in an atom percentage ranging from 0.01% to 20%.

15. The write-once optical recording medium of claim 1, wherein said reflective layer contains Ag in an atom percentage ranging from 93% to 100%.

16. The write-once optical recording medium of claim 1, wherein said reflective layer further contains a reflectivity-enhancing additive in an atom percentage ranging from 0.01% to 3.0% and selected from the group consisting of Pd, Cu, Pt and alloys thereof.

17. The write-once optical recording medium of claim 1, wherein said reflective layer further contains a corrosion resistance-enhancing additive in an atom percentage ranging from 0.01 to 2.0% and selected from the group consisting of Sc, Be, Ti, Cr, Zn, Ni, and alloys thereof.

18. The write-once optical recording medium of claim 1, wherein said reflective layer further contains a mechanical strength-enhancing additive in an atom percentage ranging from 0.01% to 2.0% and selected from the group consisting of Ba, Sc, Si, Ti, In, Ge, Zn, Bi, and alloys thereof.

19. The write-once optical recording medium of claim 1, wherein said recording layer contains Si in an atom percentage ranging from 80% to 100% and wherein said reflective layer contains Al in an atom percentage ranging from 93% to 100%.

20. The write-once optical recording medium of claim 1, wherein said recording layer contains Sb in an atom percentage ranging from 80% to 100% and wherein said reflective layer contains Ag in an atom percentage ranging from 93% to 100%.
